(19) United States
(12) Patent Application Publication
(10) Pub. No.: US 2016/0196558 A1
(43) Pub. Date: Jul. 7, 2016

(54) RISK ASSESSMENT BASED ON CONNECTED WEARABLE DEVICES

(71) Applicant: EBAY INC., San Jose, CA (US)

(72) Inventors: Richard Mercille, San Jose, CA (US); David Edward Eramian, Mountain View, CA (US); Michael McKay, San Jose, CA (US); Michael Voege, Santa Clara, CA (US)

(21) Appl. No.: 14/589,524

(22) Filed: Jan. 5, 2015

(51) Int. Cl. G06Q 20/40; G06Q 20/32

(52) U.S. Cl. CPC G06Q 20/4016; G06Q 20/3278

(57) ABSTRACT

A system or a method is provided that detects or establishes a connected network of personal or wearable devices of a user whereby the number and type of devices connected to that network are used to determine a security or confidence level for a particular transaction being attempted. The personal or wearable devices may include one or more of a smart watch, a mobile phone, a car, a smart belt buckle, smart key fob, or any other personal or wearable devices. Information indicating the number and composition on the various connected devices may be communicated from a user device requesting a payment transaction to a merchant or a payment service provider. The information indicating the number and composition of connected devices may be used for risk assessment to determine the confidence level or security level for the transaction requested by the user.

### BACKGROUND

1. Field of the Invention

The present invention generally relates to risk assessment of transactions, and more particularly, to systems and methods for implementing risk assessment of transactions based on connected wearable devices.

2. Related Art

With the popularity of wearable devices, consumers increasingly are using wearable devices to conduct various transactions and interactions. For example, consumers may shop, make electronic payments, and/or communicate electronically via wearable devices. However, wearable devices, by the nature of their compact size and portability, are often targets of theft or are often misplaced by their users. Further, wearable devices also have limited functionalities and usability due to their small form factor and/or small displays. As such, user authentication and security are particular concerns for transactions that involve wearable devices. Therefore, there is a need for a system and/or a method that provides risk assessment and security enhancement for transactions that involve wearable devices.

### BRIEF DESCRIPTION OF THE FIGURES

FIG. 1 is a block diagram of a networked system suitable for implementing risk assessment based on connected wearable devices according to an embodiment.

FIG. 2 is a block diagram of a wearable device suitable for risk assessment based on connected wearable devices according to one embodiment.

FIG. 3A is a diagram illustrating a perspective front view of a watch type wearable device according to one embodiment.

FIG. 3B is a diagram illustrating a perspective rear view of the watch type wearable device of FIG. 3A according to one embodiment.

FIG. 3C is a diagram illustrating a perspective view of a band type wearable device according to one embodiment.

FIG. 3D is a diagram illustrating a perspective view of a ring type wearable device according to one embodiment.

FIG. 3E is a diagram illustrating perspective view of a glasses type wearable device according to one embodiment.

FIG. 3F is a diagram illustrating perspective view of a belt type wearable device according to one embodiment.

FIG. 4 is a block diagram of a computer system suitable for implementing one or more components in FIG. 1 according to one embodiment.

FIG. 5 is a flow chart illustrating a set up process for implementing risk assessment based on connected wearable devices according to one embodiment.

FIG. 6 is a flow chart illustrating a method for implementing risk assessment based on connected wearable devices according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or a method may be provided that may detect or establish a connected network of personal or wearable devices of a user whereby the number and type of devices connected to that network may be used to determine a security or confidence level for a particular transaction being attempted. The personal or wearable devices may include one or more of a smart watch, a mobile phone, a car, a smart belt buckle, smart key fob, glasses, or any other personal or wearable devices that have communication capabilities. In some embodiments, the system may detect devices of other users who are related to the user and that are near the user. In an embodiment, the system may detect devices that are not in the vicinity of the user. For example, a primary user may enable or disable a wearable device which is not with the primary user. As such, stolen or misplaced wearable devices may be disabled or deactivated, such that they no longer perform transactions.

In an embodiment, the system may detect the setting, location, and/or context of the transaction based on other devices detected at a certain location. For example, the system may detect that the user is at home because certain devices at home, such as a home entertainment system, a smart fridge, a connected thermostat, a spouse's smartphone, or other devices associated with the home location are detected by the system. As such, the user may be authenticated, such as for an online transaction, based on the detected devices.

Information indicating the number and composition of the various connected devices may be communicated from a user device requesting a transaction to a merchant or a payment service provider. The information indicating the number and composition of connected devices may be used for risk assessment to determine the confidence level or security level for the transaction requested by the user. In an embodiment, the system may detect the number and composition of personal or wearable devices that are currently in communication with the user device being used to request or make a transaction and may use a risk engine to determine allowed types of transactions and/or user authentication requirements based on the number and/or composition of connected personal or wearable devices. For example, the system may allow transactions with lower amounts when a smaller number of personal or wearable devices are detected or connected to the user device used for requesting or making the transactions (e.g., when only one device is detected, allow transaction amount up to $5.00). The system may allow transactions with larger amounts when a greater number of personal or wearable devices are detected or connected to the user device used to make the transactions (e.g., when three devices are detected, all transaction amounts up to $50).

In another example, the system may require different levels of credentials for user authentication based on the number and composition of personal or wearable devices that are detected. For example, the system may require the user to input both the user ID and password when only one wearable device is detected and may require only the user ID when two or more wearable devices are detected. The system also may allow the user to define and/or customize different security levels of authentication based on the user's preferences. For example, the user may define two different security levels of authentication, a first security level requiring both user ID and password and a second security level requiring only the user ID.

In an embodiment, the system may use not only the number and composition of connected devices, but also the history about the number and composition of devices that are connected to assess risk for transactions. In particular, connection or use history of various devices for certain transactions may be established and defined by monitoring the user's various transactions and the devices used or connected during the various transactions. Connection profiles may then be established for certain types of transactions. For example, a user may typically wear the smart watch but not the user's smart glasses when paying for a meal (about $15) at a certain restaurant, because the user typically visits the gym to exercise after the meal. As such, the system may learn and remember this particular routine transaction at the restaurant for the user and may allow the transaction. But for other $15 transactions, the system may require at least two different connected wearable devices to allow the transactions.

As such, a user may more easily perform a transaction, such as making a payment without entering an authenticator like a password or PIN, when the user is detected as having a plurality of connected devices. Other user authentication methods, such as automatic authentication or authentication via biometric verification and the like, also may be implemented. Additionally, a service provider, such as a payment provider, may decrease the occurrences of fraudulent transactions through detection of a network of devices associated with the user.

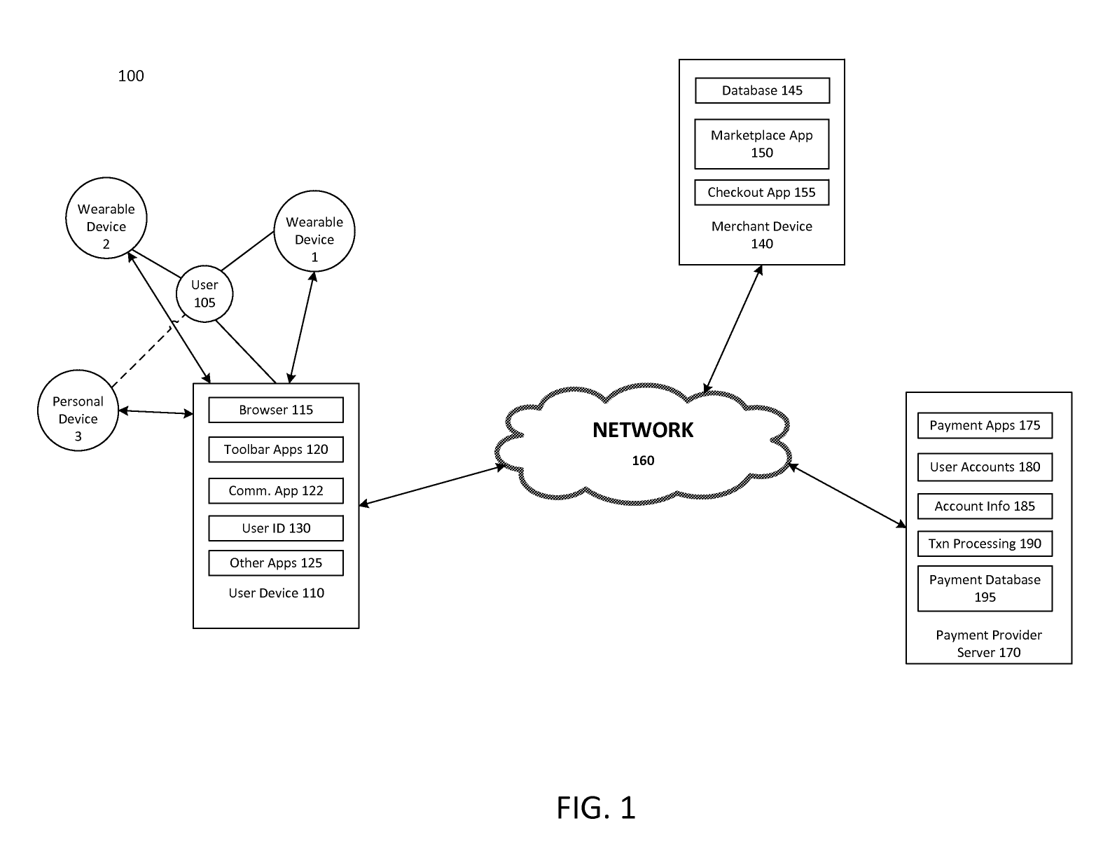

FIG. 1 is a block diagram of a networked system suitable for implementing risk assessment based on connected personal or wearable devices according to an embodiment.

Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. A wearable device 1 and a wearable device 2 may be worn by user 105 and may communicate with user device 110. A personal device 3, such as a laptop computer, a tablet, a car, or any devices associated with the user 105 also may communicate with user device 110. Payment provider server 170 may be maintained by a payment service provider, such as PayPal, Inc. of San Jose, Calif., a bank, a credit card company, and etc. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account. Although only one merchant server is shown, a plurality of merchant servers may be utilized if the user is purchasing products or services from multiple merchants.

In some embodiments, the user 105 may have a payment account at the payment provider server 170. The payment account may allow user 105 to purchase and/or pay for various products or services at a merchant. The user 105 may be required to enter credentials for user authentication at the user device 110 to access and use the payment account. One or more of the wearable devices 1 and 2, and the personal device 3 may be associated with the payment account of the user 105 and be used for risk assessment and/or user authentication. Each of the wearable devices 1 and 2 and the personal device 3 may emit a wireless signal, such as Bluetooth signal, Bluetooth Low Energy (BLE) signal, or other Near-Field Communication (NFC) signals, to communicate with the user device 110. The connection status of various wearable devices and/or personal devices to the user device 110 may be used for risk assessment and/or user authentication. The wearable devices and/or personal devices also may include sensors or input devices that allow for authentication via biometric verification, such a fingerprint scanner or a heart rate sensor. Although two wearable devices and one personal device are depicted, any number of wearable devices or personal devices may be connected to the user device 110 and their connection status may be used for risk assessment and/or user authentication.

User device 110, merchant server 140, payment provider server 170, and wearable devices 1, 2, and personal device 3 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, laptop computer, a wearable computing device, and/or other types of computing devices capable of transmitting and/or receiving data, such as an iPad™ from Apple™

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may include a short distance communication device, such as a Bluetooth device or a Near-Field Communication (NFC) device configured to communicate with other devices located near the user device 110. The Bluetooth device may implement low energy Bluetooth (BLE) communication. For example, user device 110 may communicate with wearable devices 1, 2, or personal device 3 via BLE or NFC communication to provide and receive information for various functions provided by the wearable devices or personal devices.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes service providers as well as banks and retailers. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155, which may be configured to facilitate the purchase by user 105 of goods or services online or at a physical POS or storefront. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider, which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information, which may be used to facilitate online transactions by user 105. In an embodiment, the account information 185 also may include information about wearable devices of the user 105 that are associated with the user account of the user 105 and that may be used to provide user authentication for accessing the user account. The account information 185 also may include body chemistry profile of the user 105. The body chemistry profiles may include biometric data of corresponding users. These body chemistry profiles may be encrypted to provide data security. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

When the user 105 is requesting or initiating a transaction using the user device 110, the user device 110 may detect the wearable or personal devices connected to the user device 110 and may provide information regarding the number and types of wearable or personal devices connected to the user device 110 to the merchant or the payment service provider. The information regarding the number and types of wearable or personal devices connected to the user device 110 may be used for risk assessment and/or user authentication for the requested transaction. In an embodiment, the user device 110 may detect personal devices or wearable devices of other users and may use the detection of the other users' devices for risk assessment and/or user authentication.

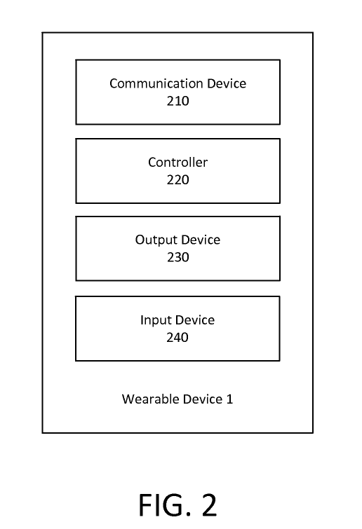

FIG. 2 is a block diagram of a wearable device 1 suitable for implementing user authentication according to one embodiment. Wearable device 1 may be a wearable item that may be worn by the user 105 or be attached to the user 105 or other items carried by the user 105. As such, the wearable device 1 may be a personal item to the user 105 that is worn or carried by the user 105.

The wearable device 1 may include a communication device 210 configured to communicate with other devices. The communication device 210 may include a short-range communication device, such as a Bluetooth or Bluetooth Low Energy (BLE) communication device, a Near-Field Communication (NFC) device, WiFi, or a combination thereof. In an embodiment, the communication device 210 may include a signal emitter configured to emit a wireless signal, without receiving communication from others. The communication device 210 may be configured to emit a unique wireless signal including unique patterns and/or frequencies, without a signal receiver. As such, the wearable device 1 may remain compact and low cost. In another embodiment, the communication device 230 may be configured to include a signal transmitter and a signal receiver to emit and receive communication signals. The signal range of the communication device 210 may be limited to a few feet, such that nearby devices may detect and/or communicate wirelessly.

The wearable device 1 may include a controller 220 configured to manage and control various operations of the wearable device 1. The controller 220 may include a microprocessor, an integrated circuit, or a combination thereof. The controller 220 may make determinations or decisions regarding controlling the operations of other devices, such as a communication device 210 and/or the output device 230. For example, the controller 220 may control the communication device 210 to communicate with the user device 110.

The wearable device 1 may include an output device 230 configured to communicate with user 105. For example, output device 230 may be an audio signal emitter configured to emit audio signals to the user 105. In another example, output device 230 may be an LED component configured to provide visual output. In still another example, output device 230 may be a vibration device configured to vibrate to communicate with user 105. In some embodiments, output device 230 may include one or more types of different output devices, such as a combination of an LED component and an audio signal emitter to provide different types of outputs to the user 105. In some embodiments, the output device 230 may be provided at the user device 110 at which various information is communicated to the user 105.

The wearable device 1 may also include an input device 240 configured to receive input from the user 105. The input device 240 may receive instructions from the user 105, such as a touch screen, buttons, dials, and the like. The input device 240 also may include sensors configured to detect user 105 or user 105's biometric information, such as fingerprint, heart rate, and the like. The biometric information may be used for user authentication.

The wearable device 1 may be powered by a battery, which may be a rechargeable battery. For example, the wearable device 1 may be powered by solar battery or by kinetic energy, such as the movement of user 105. In another example, the wearable device 1 may be powered by replaceable batteries. In some embodiments, the wearable device 1 may include low power components, such as e-ink display, that require very little battery.

Wearable device 2 of FIG. 1 may include one or more similar components of wearable device 1. Similarly, personal devices, such as personal device 3, may include similar components as those of wearable device 1. Personal devices may connect and/or communicate with user device 110 when the personal devices are in close proximity to the user device 110. For example, personal devices may include the wearable devices, a car, a desktop computer, a laptop computer, a tablet computer, a camera, a printer, and any other devices that are configured to connect with user device 110 when in proximity to the user device 110.

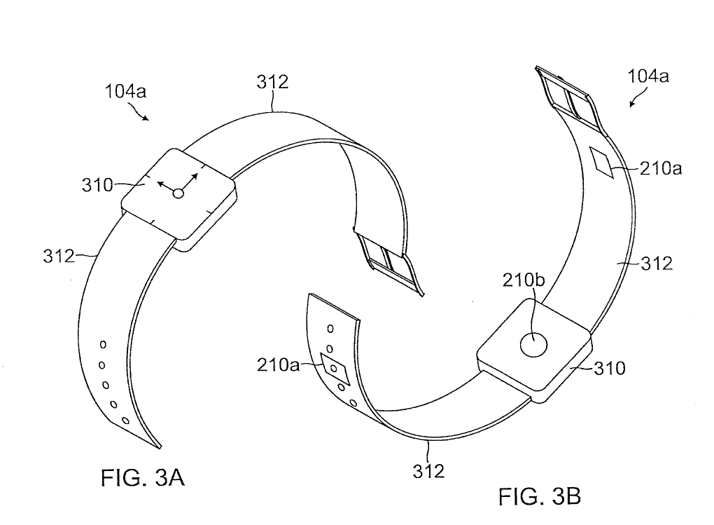

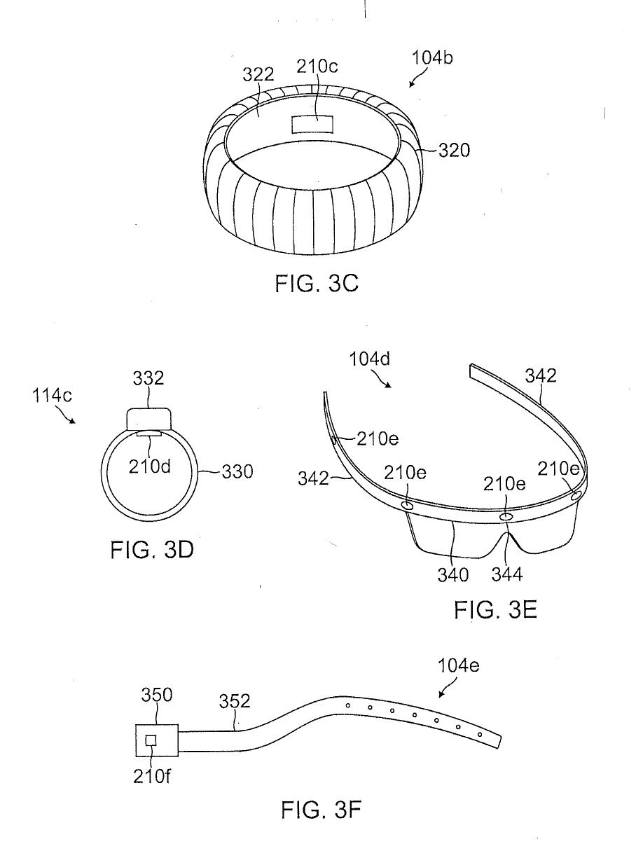

FIG. 3A is a diagram illustrating a perspective front view of a watch type wearable device 104a according to one embodiment. The watch type wearable device 104a may include a watch case 310 within which various components, controller 220, communication device 210 and output device 230, are disposed. The watch case 310 may include a front surface configured to display time. The front surface may be a glass surface and may include a touch screen configured to receive inputs from the user 105. The watch type wearable device 104a also may include fastening portions 312 configured to fasten the watch type wearable device 104a to the user 105.

FIG. 3B is a diagram illustrating a perspective rear view of the watch type wearable device 104a of FIG. 3A according to one embodiment. The rear surface of the watch case 310 may include a sensor 210b. When the watch type wearable device 104a is worn by the user 105 or fastened to the user 105, the rear surface may contact the user 105, such as a wrist of the user 105.

FIG. 3C is a diagram illustrating a perspective view of a band type wearable device 104b according to one embodiment. The band type wearable device 104b may include a band body 320 within which various components, such as controller 220, communication device 210 and output device 230, are disposed. The band body 320 may include an inner surface 322 configured to contact the user 105 when the band type wearable device 104b is worn by the user 105. The inner surface 322 of the band body 320 may include a sensor 210c. When the band type wearable device 104b is worn by the user 105 or fastened to the user 105, the inner surface 322 may contact the user 105, such as a wrist of the user 105. The sensor 210c provided on the inner surface 322 also may contact the user 105. The band type wearable device 104b may be a functional wrist band or a jewelry piece, such as a wrist band, a neck collar, and the like.

FIG. 3D is a diagram illustrating a perspective view of a ring type wearable device 104c according to one embodiment. The ring type wearable device 104c may include a ring body 330 and a setting 332. Various components, such as controller 220, communication device 210 and output device 230, may be disposed in the ring body 330 and/or setting 332. A sensor 210d may be provided at the setting 332. When the ring type wearable device 104c is worn by the user 105, a bottom surface or inner surface of the ring body 33 and setting 332 may contact the user 105. The sensor 210d provided on the inner surface also may contact the user 105 to collect the user's biometric information for user authentication.

FIG. 3E is a diagram illustrating perspective view of a glasses type wearable device 104d according to one embodiment. The glasses type wearable device 104d may include an eyeglass frame including temple portions 342 connected to lens frames 340 via hinges 346. The lens frames 340 include a bridge portion 344. Various components, such as controller 220, communication device 210 and output device 230, may be disposed in the glass frame. In an example, sensors 210e may be provided on the bridge portion 344 to detect user contacts. Sensors 210e also may be provided on inner surfaces of temple portions 342 to detect user contacts.

FIG. 3F is a diagram illustrating perspective view of a belt type wearable device 104e according to one embodiment. The belt type wearable device 104e may include a belt buckle portion 350 and a belt portion 352. Various components, controller 220, communication device 210 and output device 230, may be disposed in belt buckle portion 350. In an example, a sensor 210f may be provided at the belt buckle portion 350.

Other types of wearable devices that may be attached to or carried by the user 105, such as to the user or to the user's clothing, bags, or other personal items, also may be utilized. For example, the wearable device 1 may be earrings, ear buds, or a clip configured to attach to the user 105 or items carried by the user 105. In another example, the wearable device 1 may be a tab that may be inserted or placed inside a bag or a wallet of the user 105. Other personal, but non-wearable devices, also may be used for risk assessment and/or user authentication. For example, personal devices, such as a desktop computer, a laptop computer, an in-car information or entertainment console, and the like may connect to the user device 110 and their connection status may be used for risk assessment.

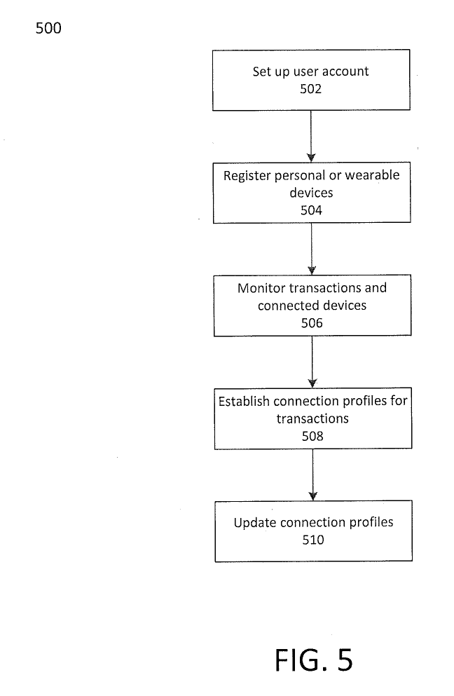

FIG. 5 is a flow chart illustrating a set up process 500 for implementing risk assessment based on connected wearable devices according to one embodiment. Initially, the user 105 may set up a user account at the merchant or at the payment service provider. In an embodiment, the user 105 may download an application for making and managing transactions from the merchant or the payment service provider to the user device 110. The user 105 may create a user profile for making transactions. For example, the user 105 may enter name, address, social security number, phone number, other contact information, birthday, age, funding sources for transactions, and other financial or personal information. The user 105 also may create a user ID and/or password for user authentication and/or for accessing the user account to make and/or manage transactions.

At step 504, the user 105 may register personal or wearable devices. The user 105 may enter the type and name of wearable devices the user 105 uses and/or connects to the user device 110. The user 105 may be allowed to enter the type, description, usage, and other additional information regarding each personal or wearable device. For example, the user 105 may indicate that certain wearable devices are used for certain settings, locations, certain day, time, season or certain environments, and/or transaction details (limits, location, merchant name, merchant type, type of purchase, etc.). In another example, the user 105 also may indicate that certain personal or wearable devices are often used together. In an embodiment, the user device 110 may automatically compile a list of the user 105's personal or wearable devices that have or had been connected to the user device 110 and send the list to the merchant or the payment service provider to be associated with the user 105's user account.

At step 506, the system may monitor transactions and personal or wearable devices connected to the user device 110. In particular, the system may monitor the different personal or wearable devices that are connected to the user device 110 at different locations, times, or settings. For example, the system may detect that the user device 110 typically is connected to the user 105's work computer, the user 105's smart watch, and the user 105's work cell phone during regular business hours, and that the user device 110 typically is connected to the user 105's smart watch and the user 105's home entertainment devices when the user 105 is home after business hours.

In an embodiment, the system may monitor the personal or wearable devices connected to user device 110 when the user 105 uses user device 110 to make or initiate a transaction. For example, when the user 105 makes a payment transaction using user device 110 at a grocery store, the system may monitor and/or detect that the user 105's smart watch and the user 105's smart ring are connected to the user device 110. This may be a routine transaction and the two devices are connected to the user device 110 during the routine transaction. Thus, the system may learn different routines and/or habits of the user 105 related to transactions made via user device 110 and the combination of devices connected to the user device 110 during the routine transactions (which can include locations, times, purchase amounts, etc.).

At step 508, based on the connection status of different personal and/or wearable devise at the user device 110 and the user 105's routines and/or habits, such as routine transactions or routine visits to certain locations or merchants, the system may establish various connection profiles for various types of transactions. The connection profiles may define settings and/or connection status of the user 105's personal and/or wearable devices during certain types of transactions. For example, a connection profile for a routine transaction at a restaurant may include the location of the transaction, the restaurant or payee of the transaction, the typical amount of the transaction, the devices connected to the user device 110 during the transaction, and the like. Connection profiles also may be established for various settings, locations, situations, times, and the like, for the purpose of risk assessment at these different settings, locations, situations, times, and the like. Thus, the connection profiles may define the connection status of various personal or wearable devices, for the purpose of risk assessment. For example, when the connection status of the personal or wearable devices deviates from those defined in the connection profile, the system may determine a higher security risk.

In an embodiment, the connection profile may define different connection arrangements in terms of probability. For example, the connection profile may define that, for a banking transaction, there is a 73% chance that devices A, B, and C are connected to the user device 110, a 20% chance that devices A and C are connected to the user device 110, and a 7% change that no devices are connected to the user device 110. Thus, the probabilities associated with different connection arrangements may be considered for risk assessment. For example, if the detected connections at the user device 110 match the connection arrangement with a higher probability as defined in the connection profile, there is a higher probability that the user device 110 is operated by the user 105.

At step 510, the system may continue to monitor and detect the connection status of the personal and/or wearable devices connected at the user device 110 and may update the various connection profiles to reflect the most recent routines of the user 105. In an embodiment, the user device 110 may detect other users' personal or wearable devices and may use the connection status of the other users' devices detected by the user device 110 for risk assessment. For example, when the user 105 is at home, the user device 110 may detect the user 105's other family members' devices which may indicate that the user 105 is at home and the presence of the other family members' devices may further confirm the user 105's security status.

Thus, the process 500 may allow the system to monitor the connection status of various personal and/or wearable devices detected by or connected to the user device 110 at various settings, locations, and/or transactions. The system also may set up connection profiles defining routine connection status of the user 105's personal and/or wearable devices at the user device 110 for different locations, settings, and/or transactions. These connection profiles may be used to assess the risk or security level of the transactions. Further, the system may continuously monitor and update the connection profiles to have the most up-to-date connection profiles. In addition, the system may provide merchants with additional security information to implement risk assessment for various transactions requested by customers.

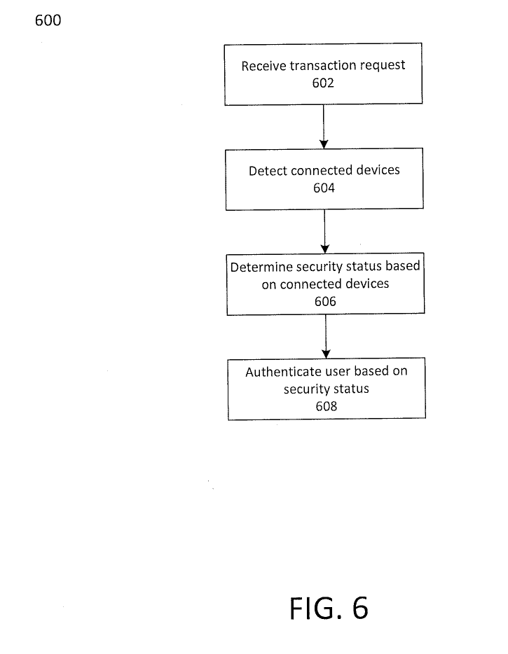

FIG. 6 is a flowchart illustrating a method 600 for implementing risk assessment based on connected wearable or personal devices according to one embodiment. At step 602, the user device 110, the merchant, or the payment service provider, may receive a request for transaction from the user 105. The transaction request may be a request for a payment transaction, a fund transfer transaction, a request for certain information, such as financial information or other personal information, a request to access certain accounts, and the like. In some embodiments, the transaction request is a request to access a certain location, building, event, or the like.

At step 604, the user device 110 may detect other devices connected to the user device 110. In particular, the user device 110 may detect user 105's personal and/or wearable devices that are connected to the user device 110. For example, the user device 110 may detect the user 105's smart watch, the user 105's laptop computer, or the user 105's fitness monitor. In some embodiments, the user device 110 may detect devices of other nearby users, such as the user 105's family members' devices, the user 105's co-worker's devices, and the like.

In an embodiment, the user device 110 may determine a connection status of the various detected device. In particular, the user device 110 may detect the type of communication, such as Bluetooth, Near-Field Communication (NFC), Bluetooth Low Energy (BLE), WiFi, or the like. The user device 110 also may detect the security settings for the various connections. For example, some devices may be paired with user device 110 to implement certain communication with the user device 110. The paired communication may include PIN or password and may be encrypted. In another example, the connection may be public and may be accessible by others. In still another example, the connection may be a secured network connection, such as WiFi with network encryptions. In some embodiments, some devices may be detected but may not be set up for communication with the user device 110. For example, other users' devices may be detected by the user device 110, but may not be set up for communication with the user device 110 to exchange information with the user device 110. Thus, the connection status of various devices detected by or connected to the user device 110 may be determined.

Further, the user device 110 also may determine a connection history of each detected devices. In particular, how long a device has been detected and/or connected to the user device 110, the volume of data transmission between the detected device and the user device 110, the type, pattern, and speed of data transmission between the detected device and the user device 110, the frequency of the data transmission, and the like also may be determined. For example, a smart watch may have been connected to the user device 110 for 20 hours with average data transmission volume of one megabyte per hour and data exchange frequency of every minute. Thus, the connection history and communication activity history of the detected devices also may be retrieved or determined.

At step 606, the system may determine a security status based on the detected or connected devices. In an embodiment, the risk assessment may be implemented at the user device 110. In some embodiments, information regarding the detected or connected devise may be communicated to the merchant or the payment service provider along with the transaction request and the merchant or the payment service provider may implement the risk assessment and take a desired action based on the risk assessment, such as approving a payment request without the user having to enter an authenticator such as a PIN, password, or biometric.

The system may find a connection profile that matches the particular type of transaction requested or that matches the particular location or setting of the requested transaction. For example, the transaction may be a payment transaction at a hotel and the system may find the connection profile of the user 105 for the hotel or for the type of hotels. The user 105 may have stayed routinely at the hotel and the system may have established a connection profile for that particular hotel. In another example, the transaction may be a fund transaction to a particular user. The system may find the connection profile for making a fund transaction to the particular user. Thus, the system may find the connection profile that best matches the transaction or the type of transaction being requested at the user device 110.

Based on the connection profile, the system may determine the routine connection status of the user 105's personal and/or wearable device for the requested transaction. For example, the connection profile may indicate that the user 105 routinely has a fitness tracker and a smart watch connected to the user device 110 when the user 105 is making a payment at a gym. In another example, another connection profile may indicate that the user 105 typically has a smart ring and a laptop computer connected to the user device 110 when the user 105 is logging into the user 105's bank account at home. Thus, the system may find the matching connection profile that defines the routine connection status of devices at the user device 110 for a routine transaction.

The system may then compare the current connection status at the user device 110 with the connection status as defined in the connection profile. In particular, the system may compare and determine how many of the devices as defined in the connection profile are now connected to or detected by the user device 110. Further, the system may compare and determine the connection status of the devices, such as the type of connection, connection history, data transmission history, and the like.

For example, the connection profile may define devices A, B, and C as devices routinely connected to the user device 110 for the particular transaction. The user device 110 may detect that only A and C are currently connected to the user device 110. Thus, the system may determine that there is a risk associated with this particular transaction, because device B is not detected or connected, which is a deviation from the routine. If only device A is detected or connected, the system may determine that there is a higher risk, because two out of three devices are missing, which is a greater deviation from the routine, and require heightened or additional user authentication.

In an embodiment, the system may calculate a security score as an indication of risk for the transaction. In particular, the security score may be calculated based on the number of devices that are connected to the user device 110, how similar the connection status of each detected or connected device is compare to those defined in the connection profile, and how much deviation the current connection status is from those defined in the connection profile.

For example, the connection profile may define a routine connection as a device X with a constant Bluetooth communication connection, a device Y with intermittent WiFi connection, and a device Z with frequent BLE connection. The user device 110 may currently have a device X with intermittent Bluetooth connection, a device Z with frequent BLE connection, and a device W with a dormant Bluetooth communication. By comparing the risk file with the current connection status of the user device 110, the system may determine a score of 10 for each matching device, a score of −10 for each missing device, a score of 15 for matching communication status, a score of 10 for semi-matching communication status, a score of 10 for an additional device not defined in the connection profile, and the like. The example above has a matching device X with semi-matching connection status (20 points), a matching device Z with matching connection status (25 points), an additional device W (10 points), and a missing device Y (−10 points) with a total of 45 points.

In some embodiments, no connection profile is found for a transaction, because the transaction is a new type of transaction. As such, the system may calculate a security score mainly based on the number and/or composition of the user 105's personal and/or wearable devices that are connected to user device 110 during the transaction. For example, each of user 105's connected devices may be given 10 points and each of other users' devices may be giving 5 points. For example, if two of the user 105's device are detected or connected and one device of user 105's family member is detected during the transaction, the system may determine the security score to be 25 points.

In an embodiment, different types of devices may be weighted differently for the purpose of security score calculation. For example, devices that are more personal or more attached to the user 105, such as a smart watch that is strapped to the user 105's wrist or a smart ring on the user's 105 finger, may be weighted more than devices that are not as personal or not attached to the user 105, such as a desktop computer. In another embodiment, connections that have higher security, such as an encrypted Bluetooth communication, may be weighted more for determining the security score than connections that require less security, such as an open or public WiFi connection.

In an embodiment, connection status that is more unique to the user 105, such as a pattern of data transmission history may be weighted more for security score calculation than a connection status that is not as unique or specific to the user 105, such as a connection time length. Accordingly, a security score may be calculated based on various factors and in view of the user 105's connection routine in the connection profile. Different factors also may be weighted differently according to their relative uniqueness and/or importance.

At step 608, the system may authenticate user, approve a transaction, or implement security measures based on the security status or security score. In an embodiment, the system may require user credentials for the transaction based on the level of security score.

For example, when the security score is below 30, the system may require that the user 105 enter the user ID and password for the user account to continue with the transaction. When the security score is above 50, the system may allow the transaction automatically without requesting user credentials. In an embodiment, the system may flag certain transactions for further review when the security score for the transaction is above a certain threshold. For example, when the security score for a transaction is below 40, the system may allow the transaction but may flag the transaction for further review later.

In an embodiment, the system may determine a transaction amount limit based on the security score or the security status. For example, for a security score below 30, the system may allow a transaction of up to $25; for a security score below 40, the system may allow a transaction of up to $50; and for a security score below 50, the system may allow a transaction of up to $100. In an embodiment, based on the security status or security score, the system may cancel the transaction and may notify the user 105 the reason for the cancelation. For example, based on the connection status, the system may determine that there are many deviations in the connection status of the user device 110 from the user 105's routine, such as many unknown devices connected to the user device 110. The system may cancel the transaction and may notify the user 105. The user 105 may need to be re-authenticated into the user 105's account before further transactions are allowed.

By implementing processes 500 and 600, risk assessment may be implemented based on connected personal and/or wearable devices at the user device 110. In particular, the system may establish various connection profiles by monitoring and learning the user 105's routines related to transactions. Various connections status, such as a number and composition of devices connected to the user device 110, connection types, data transmission volume, speed, and pattern, security settings, and other connection status may be used for assessing the risk or security level for a transaction. The system may then determine appropriate security measures based on the risk or security levels.

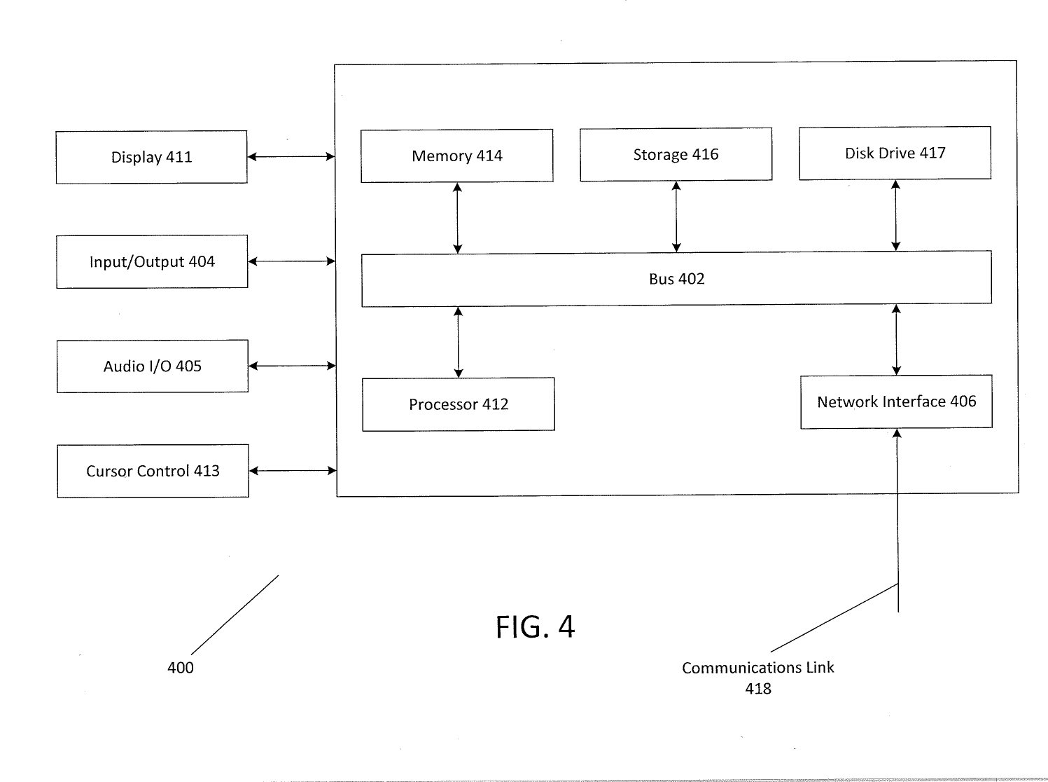

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, Bluetooth device, key FOB, badge, wearable computing device, etc.)

capable of communicating with the network. The merchant and/or payment provider may utilize a network-computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.).

An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing a connection profile of a user, the connection profile comprising information about transactions involving connected devices of the user;
one or more processors in communication with the memory and adapted to:
receive a request for a transaction initiated from a first user device;
determine a connection status of the first user device indicating a number and a composition of personal devices connected to the first user device when the transaction is initiated;
determine a security status for the transaction based, at least in part, on the connection status of the first user device; and
process the request for the transaction based, at least in part, on the security status.

2. The system of claim 1, wherein the request for the transaction comprises the connection status of the first user device comprising one or more of the number and the composition of personal devices connected to the first user device, types of the personal devices, a location of the transaction, a time of the transaction, and an amount of the transaction, and parties of the transaction.

3. The system of claim 1, wherein the one or more processors are further adapted to:
compare the connection status of the first user device with routine connection arrangements defined in the connection profile; and
calculate a security score based on a number of matching personal devices between the connection status of the first user device and the routine connection arrangements defined in the connection profile.

4. The system of claim 1, wherein the connection profile defines one or more of a connection type, a connection history, and a security setting for each of the personal devices included in routine connection arrangements defined in the connection profile.

5. The system of claim 4, wherein the connection history comprises one or more of a connection length, a data transmission volume, a data transmission speed, and a data transmission pattern.

6. The system of claim 4, wherein the connection type comprises one or more of a Bluetooth communication, a Bluetooth Low Energy communication, a Near-Field Communication, and a WiFi communication.

7. The system of claim 1, wherein the memory stores a plurality of connection profiles associated with various types of transactions, and wherein the one or more processors are further adapted to:
select a particular connection profile from the plurality of connection profiles, wherein the particular connection profile is associated with the same type of transactions as that of the transaction requested by the user; and
compare the connection status of the first user device with routine connection arrangements as defined in the particular connection profile.

8. The system of claim 1, wherein the one or more processors are further adapted to determine an authentication requirement for the transaction based on the security status.

9. The system of claim 8, wherein the one or more processors are further adapted to automatically authenticate the user for the transaction without requiring user credentials when the security score exceeds a threshold.

10. The system of claim 1, wherein the one or more processors are further adapted to determine an amount limit of the transaction based on the security status.

11. The system of claim 1, wherein the one or more processors are further adapted to flag the transaction for further review based on the security status.

12. The system of claim 1, wherein the one or more processors are further adapted to cancel the transaction based on the security status.

13. A method comprising:
receiving a request for a transaction initiated from a first user device of a user;
determining a connection status of the first user device indicating a number and a composition of personal devices connected to the first user device when the transaction is initiated; and
determining a security status for the transaction based on the connection status of the first user device.

14. The method of claim 13 further comprising:
determining a security score indicating the security status for the transaction based on the number and the composition of personal devices connected to the first user device; and
implementing one or more security measures based on the security score.

15. The method of claim 14 further comprising increasing the security score for each personal devices of the user connected to the user device.

16. The method of claim 15, wherein types of personal devices that are more personal or more attachable to the user are weighted more in determining the security score than types of personal devices that are less personal or less attachable to the user.

17. The method of claim 15, wherein types of personal devices that have more secured connections to the first user device are weighted more in determining the security score than types of personal devices that have less secured connections to the first user device.

18. The method of claim 13, wherein the personal devices comprises one or more of a smart watch, a band, a ring, a pair of eye glasses, a necklace, and an in-car console.

19. The method of claim 13, wherein the personal devices comprises one or more of devices owned or carried by other users related to the user.

20. The method of claim 15, wherein the personal devices owned or carried by the user are weighted more for determining the security score than devices owned or carried by other users.
